(19) United States
(12) Patent Application Publication
(10) Pub. No.: US 2014/0300794 A1
(43) Pub. Date: Oct. 9, 2014

(54) OPTICAL SCOPE FOR IMAGING OF AN OBJECT

(71) Applicant: CARL ZEISS SPORTS OPTICS GMBH, WETZLAR (DE)

(72) Inventor: Christian Sinn, Giessen (DE)

(73) Assignee: CARL ZEISS SPORTS OPTICS GMBH, WETZLAR (DE)

(21) Appl. No.: 14/192,918

(22) Filed: Feb. 28, 2014

Related U.S. Application Data
(63) Continuation-in-part of application No. 13/715,059, filed on Dec. 14, 2012.
(60) Provisional application No. 61/771,183, filed on Mar. 1, 2013.
(60) Provisional application No. 61/570,982, filed on Dec. 15, 2011.

(51) Int. Cl. G02B 23/02; H04N 5/232

(52) U.S. Cl. CPC G02B 23/02; H04N 5/23245
USPC 348/335; 359/431

(57) ABSTRACT

An optical scope has at least one optical element which is used to image an object. An optical element is, for example, understood to mean a lens unit, a prism, or a prism system composed of multiple prisms. A lens unit is, for example, understood to mean one single lens or a unit which is composed of at least two lenses. It is provided to make the optical element of glass, namely N-BK7HT, N-SK2HT, F2HT, N-LASF45HT, SF6HT, N-SF6HTultra, N-SF6HT, SF57HTultra, N-SF57HTultra, N-SF57HT, N-LASF9HT and/or N-BAK4HT. The above-named glasses are glasses of the SCHOTT corporation.

The invention relates to an optical scope for imaging an object, e.g. on an image detection unit. An optical scope is, for example, understood here to mean a monocular, a binocular, a telescope, or a spotting scope. Furthermore, an image detection unit is, for example, understood to mean a human eye or, for example, a digital recording medium. A CCD is in particular suitable as the digital recording medium.

Optical scopes of the above-named type are known from the prior art. The known optical scopes usually have at least one optical unit which is used to image an object. For example, the optical unit is designed as an objective lens, as an ocular, or as a prism system.

Each of the optical units in turn has at least one optical element or at least two optical elements. A single lens or a plurality of lenses, e.g. a lens component, is provided as the optical element, for example. In a prism system, the optical element is designed as a prism. Each optical element has imaging properties which is determined by the transmission of the light incident onto the optical element, among other things. The transmission is the permeability of the medium of which the optical element is composed. Depending on the property of the medium, light incident onto the optical element is reflected on at least one boundary surface of the optical element or is partially absorbed when it passes through the optical element. A certain portion of the incident light which has not been reflected and not been absorbed exits the optical element again. This portion of light is called the transmitted light.

A variable which describes the transmission is the transmittance T(λ). The latter is a function of the wavelength and is defined as the ratio of a light intensity transmitted through an optical element to a light intensity incident onto the optical element. A wavelength-based weighting provides a transmission number which also describes the property of the transmission of the optical element. In particular, sensitivity curves V(λ) of the bright-adapted human eye and V′(λ) of the dark-adapted human eye are used as weighting factors. The following equation applies:

$$T = {\int }_{- ∞}^{+ ∞} T ( λ ) \cdot V ( λ ) d λ$$

$${T}^{′} = {\int }_{- ∞}^{+ ∞} T ( λ ) \cdot {V}^{′} ( λ ) d λ$$

T is identified as the transmission number for the day transmission. T′ is identified as the transmission for the night transmission.

The transmission of an optical system (system transmission) is determined by the transmission of its individual optical elements. It is known to indicate the system transmission by a value so that the image quality of the optical system is recognized.

It is furthermore known that the transmission decreases in optical scopes from the prior art, the more optical elements are installed in the optical scope, since incident light is reflected on an increasing number of optical elements.

Furthermore, environmental conditions exist which encumber or render impossible the observation of an object using a known optical scope. For example, it is difficult to observe an object using the known optical scopes at dawn or during the night. Due to the little light incidence and due to the little transmission of the light incident into the known optical scope it is difficult to obtain a good quality image.

Reference is additionally made to WO 2004/061487 A2 and U.S. 2006/0238732 A1.

It is desirable that the optical scope (and thus also the optical units or optical elements forming the optical scope), using which an observation of an object is carried out, has the highest transmission possible. The invention is therefore based on the object of providing an optical scope which has a high transmission.

This object is achieved according to the invention by an optical scope having the features of Claim 1. Further features of the invention result from the description that follows, the appended claims, and/or the appended figures.

According to the invention, the optical scope is designed to image an object. It has at least one first optical element and at least one second optical element. Both the first optical element and the second optical element are used to image the object. Here, an optical element is, for example, understood to mean a lens unit, a prism, or a prism system composed of multiple prisms. A lens unit is, for example, understood here to mean one single lens or a unit which is composed of at least two lenses.

It is now provided to make the first optical element of glass, namely of at least one of the following glasses (glass types): N-BK7HT, N-SK2HT, F2HT, N-LASF45HT, SF6HT, N-SF6HTultra, N-SF6HT, SF57HTultra, N-SF57HTultra, N-SF57HT, N-LASF9HT as well as N-BAK4HT. The above-named glasses are glasses of the SCHOTT corporation. It is furthermore provided to make the second optical element of a lead-containing glass for increasing the transmission.

The optical scope according to the invention is based on the surprising finding that the transmission of the optical scope is significantly improved compared to the prior art, if a first optical element which is arranged in an optical scope and is made of at least one of the glasses specified above is combined with a second optical element which contains lead. Experiments showed that an increase in transmission of up to 3% is readily achievable.

In particular, it is possible to use the optical scope to observe and image an object at unfavorable environmental conditions, e.g. at dawn or at night.

If the optical scope according to the invention has multiple first optical elements, the invention provides that at least one of these multiple first optical elements is formed by at least one of the above-named glasses specified for the first optical element. The invention does not necessarily provide that all of the multiple first optical elements are formed by at least one of the above-named glasses specified for the first optical element. However, one embodiment of the invention does provide that multiple or even each of the multiple first optical elements are/is formed by at least one of the above-named glasses specified for the first optical element.

If the optical scope according to the invention has multiple second optical elements, the invention provides that at least one of these multiple second optical elements is made of a lead-containing glass. The invention does not necessarily provide that all of the multiple second optical elements are made of lead-containing glass. However, one embodiment of the invention does provide that multiple or even each of the multiple second optical elements are/is made of lead-containing glass. In this case, it is provided, for example, that all of the second optical elements are made of an identical lead-containing glass. As an alternative thereto, it is provided that the second optical elements are made of different lead-containing glasses.

In one exemplary embodiment of the optical scope according to the invention, it is additionally or alternatively provided that the second optical element is made of at least one of the following lead-containing glasses: K7, K10, KZFS4, KZFS5, KZFS12, LAFN7, LLF1, LF5, F2, F4, F5, SF1, SF2, SF4, SF5, SF6, SF10, SF11, SF14, SF15, SF56A, SF57, SF66, F2HT, SF6HT as well as SF57HTultra. The notation refers to glasses of the Schott corporation.

In one exemplary embodiment of the optical scope according to the invention, it is additionally or alternatively provided that the optical scope has at least one objective lens which includes the first optical element. In another exemplary embodiment, it is additionally or alternatively provided that the optical scope has at least one ocular which has the second optical element. In a further exemplary embodiment of the optical scope according to the invention, it is provided in addition or as an alternative thereto that the objective lens has the second optical element and that the ocular has the first optical element. In the case of the invention, the first optical element and the second optical element can always be arranged in the optical scope in such a way that an increase in transmission is achieved.

In yet another exemplary embodiment of the optical scope according to the invention, it is additionally or alternatively provided that an image detection unit is provided which is, for example, designed as a digital recording medium, in particular as a CCD.

As already mentioned above, the first optical element is designed as a lens unit, for example, specifically as a first lens unit. In another exemplary embodiment, it is additionally or alternatively provided that the second optical element is designed as a second lens unit.

In yet another exemplary embodiment of the optical scope according to the invention, the first optical element and/or the second optical element is/are designed as a prism. In another exemplary embodiment of the optical scope according to the invention, the optical scope has multiple prisms which are arranged in the optical scope as optical elements.

In another exemplary embodiment of the optical scope according to the invention, the optical scope is designed as a monocular, a binocular, a telescope, or a spotting scope. The invention, is, however, not limited to the above-named exemplary embodiments.

The invention is now elucidated in greater detail with the aid of the figures with reference to one exemplary embodiment.

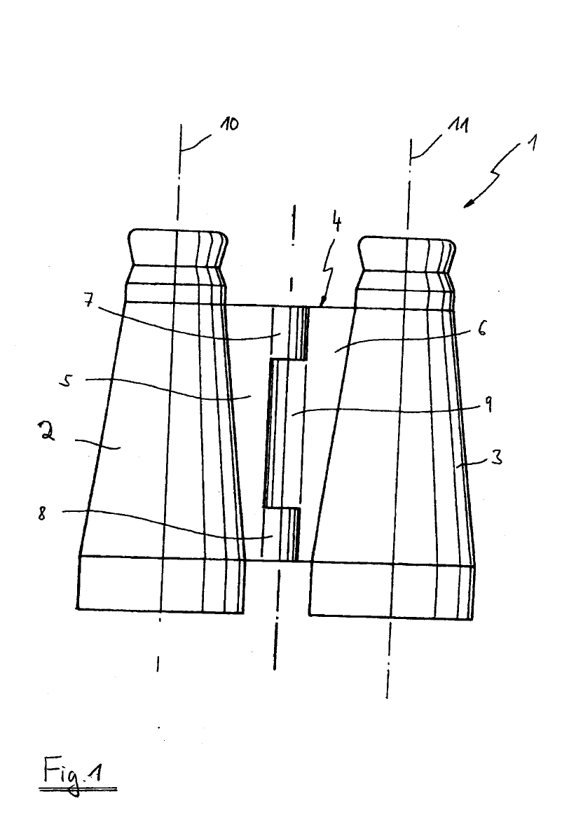

FIG. 1 shows a first schematic view of an optical scope; and

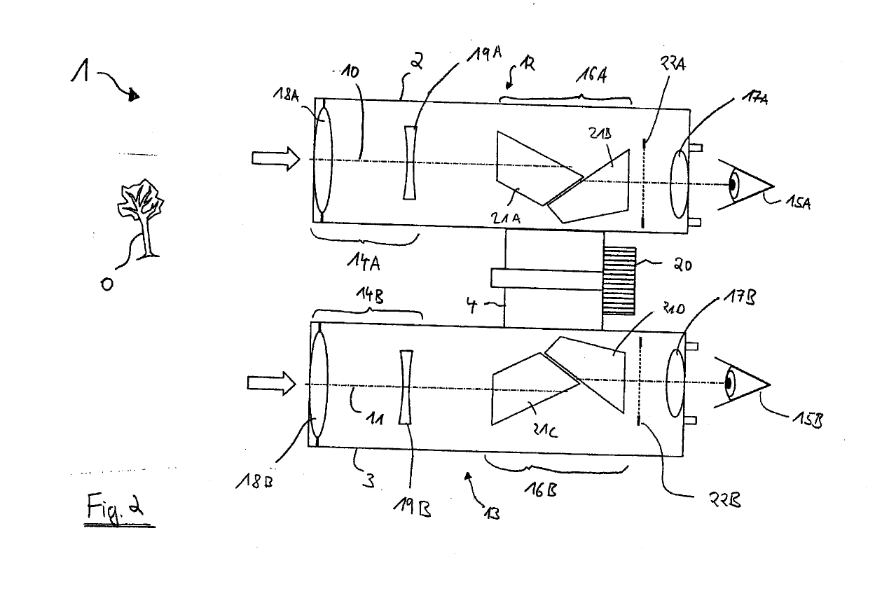

FIG. 2 shows a second schematic view of the optical scope according to FIG. 1.

The invention is discussed in the following with reference to an optical system in the form of a binocular 1 (referred to in the following only as optical scope 1). It is explicitly pointed out that the invention is not limited to a binocular. The invention is rather suitable for every optical system, for example also for a monocular, a telescope, or a spotting scope.

FIG. 1 shows a first schematic view of the optical scope 1 which has a tube-shaped first housing part 2 and a tube-shaped second housing part 3. A first optical axis 10 runs through the first housing part 2. In contrast, a second optical axis 11 runs through the second housing part 3. The first housing part 2 is connected to the second housing part 3 via a folding bridge 4. The folding bridge 4 has a first hinge part 5 which is integrally connected to the first housing part 2. Furthermore, the folding bridge 4 has a second hinge part 6 which is situated on the second housing part 3. The first hinge part 5 has a first receptacle part 7 and a second receptacle part 8 between which a third receptacle part 9 of the second hinge part 6 is situated. An axle bolt (not illustrated) runs through the first receptacle part 7, the second receptacle part 8, and the third receptacle part 9, so that the relative position of the first housing part 2 and the second housing part 3 may be attuned to one another. In this way, it is possible to attune the first housing part 2 and the second housing part 3 to the interocular distance of a user, so that, on the one hand, the first housing part 2 is situated on the one of the two eyes of the user and, on the other hand, so that the second housing part 3 is situated on the other one of the two eyes of the user.

FIG. 2 shows another view of the optical scope 1. The first housing part 2 has a first optical subsystem 12. The first optical subsystem 12 is provided with a first objective lens 14A, with a first prism system 16A, and with a first ocular 17A. On the first ocular 17A, a first eye 15A of a user may be situated to observe an object O. The first optical axis 10 of the first optical subsystem 12 is slightly offset laterally due to the first prism system 16A, so that the first optical axis 10 consequently has a stepped design.

In this exemplary embodiment, the first objective lens 14A includes a first front unit 18A and a first focusing unit 19A. Other embodiments of the first objective lens 14A provide a different number of individual lenses or lens components made of lenses. For the purpose of focusing the object O observed through the optical scope 1, either the first ocular 17A or the first focusing unit 19A may be axially displaced along the first optical axis 10.

The second housing part 3 has a second optical subsystem 13. The second optical subsystem 13 is provided with a second objective lens 14B, with a second prism system 16B, and with a second ocular 17B. On the second ocular 17B, a second eye 15B of the user may be situated to observe the object O. The second optical axis 11 of the second optical subsystem 13 is slightly offset laterally due to the second prism system 16B, so that the second optical axis 11 consequently has a stepped design.

In this exemplary embodiment, the second objective lens 14B includes a second front unit 18B and a second focusing unit 19B. Other embodiments of the second objective lens 14B provide a different number of individual lenses or lens components made of lenses. For the purpose of focusing the object O observed through the optical scope 1, either the second ocular 17B or the second focusing unit 19B may be axially displaced along the second optical axis 11.

In both above-described optical subsystems 12, 13, the beam direction of the light beams incident into the optical subsystems 12, 13 is as follows: object O—objective lens 14A, 14B—prism system 16A, 16B—ocular 17A, 17B—eye 15A, 15B.

In the exemplary embodiment described here, a rotary knob 20 is situated for focusing purposes on the folding bridge 4, this rotary knob allowing the first focusing unit 19A and the second focusing unit 19B to be jointly displaced along the optical axes 10 and 11.

In the exemplary embodiment described here, both the first objective lens 14A and the second objective lens 14B generate a real image, which is inverted in relation to the observed object O, in an image plane associated with the particular objective lens 14A, 14B. The first prism system 16A associated with the first objective lens 14A as well as the second prism system 16B associated with the second objective lens 14B are used for image erection. In this way, the inverted image is erected again and is imaged in a new image plane, the left-hand intermediate image plane 22A and the right-hand intermediate image plane 22B. The first prism system 16A and the second prism system 16B may be constructed as an Abbe-König prism system, Schmidt-Pechan prism system, Uppendahl prism system, Porro prism system, or any other prism system variant.

A first field stop which sharply defines the field of view is, for example, situated in the left-hand intermediate image plane 22A. Furthermore, a second field stop which sharply defines the field of view may be situated in the right-hand intermediate image plane 22B.

The first ocular 17A is used to image the image of the left-hand intermediate image plane 22A at any desired distance, e.g. ad infinitum or at another distance. Furthermore, the second ocular 17B is used to image the image of the right-hand intermediate image plane 22B at any desired distance, e.g. ad infinitum or at another distance.

The aperture of the first optical subsystem 12 and the second optical subsystem 13 (not illustrated) may either be formed by a mount of an optical element of the corresponding optical subsystems 12 and 13 or by a separate aperture. It may be imaged in the beam direction by the corresponding optical subsystems 12 and 13 in a plane which is situated in the beam direction behind the corresponding ocular 17A or 17B and is typically spaced at 5 mm to 25 mm therefrom. This plane is referred to as the plane of the exit pupil.

The optical scope 1 illustrated in FIGS. 1 and 2 has multiple optical units, namely the first objective lens 14A, the second objective lens 14B, the first prism system 16A, the second prism system 16B, the first ocular 17A, as well as the second ocular 17B. The first objective lens 14A is composed of multiple (first) optical elements, namely the first front unit 18A and the first focusing unit 19A. The second objective lens 14B also has multiple (first) optical elements, namely the second front unit 18B and the second focusing unit 19B. The first prism system 16A is composed of (first) optical elements in the form of a first prism 21A and a second prism 21B.

The second prism system 16B is composed of a third prism 21C and a fourth prism 21D. At least one of the abovementioned (first) optical elements of the optical scope 1 is made of at least one of the following glasses (glass types): N-BK7HT, N-SK2HT, F2HT, N-LASF45HT, SF6HT, N-SF6HTultra, N-SF6HT, SF57HTultra, N-SF57HTultra, N-SF57HT, N-LASF9HT as well as N-BAK4HT. In particular, it is provided to make at least two or each of the above-named (first) optical elements of at least one of the above-named glasses. The above-named glasses are glasses of the SCHOTT corporation.

Properties of the above-named glasses for the (first) optical element are indicated in the table below. The properties are quoted from a publication of the SCHOTT corporation.

| Glass | n_{d} | v_{d} | Tau |
|---|---|---|---|
| N-BK7HT | 1.51680 | 64.17 | 0.998 |
| N-SK2HT | 1.60738 | 56.65 | 0.996 |
| F2HT | 1.62004 | 36.37 | 0.996 |
| N-LASF45HT | 1.80107 | 34.97 | 0.886 |
| SF6HT | 1.80518 | 25.43 | 0.941 |
| N-SF6HTultra | 1.80518 | 25.36 | 0.887 |
| N-SF6HT | 1.80518 | 25.36 | 0.877 |
| SF57HTultra | 1.84666 | 23.83 | 0.924 |
| N-SF57HTultra | 1.84666 | 23.78 | 0.830 |
| N-SF57HT | 1.84666 | 23.78 | 0.793 |
| N-LASF9HT | 1.85025 | 32.17 | 0.843 |
| N-BAK4HT | 1.56883 | 55.98 | 0.993 |

In the table, the individual glass types are indicated, the notation of the glass types referring to glass types of the SCHOTT corporation. Moreover, the refractive index is denoted with the reference symbol n_{d} and the Abbe number is denoted with the reference symbol v_{d} in the table. Furthermore, the transmittance, i.e., the ratio of the light incident onto the optical element to the transmitted light, is indicated with the reference symbol Tauᵢ. The values indicated in the above-named table refer to an optical element of 10 mm thickness and at an incident light having a wavelength of 400 nm.

In this exemplary embodiment, the first ocular 17A and the second ocular 17B are each formed by an individual (second) optical element, namely an individual lens unit. This individual (second) optical element is made of a lead-containing glass, for example one of the lead-containing glasses already mentioned above. A further exemplary embodiment provides for using multiple lens units which are made of one of the lead-containing glasses mentioned above, for example of SF57HTUltra.

The combination of the (first) optical elements of the optical scope 1 with the (second) optical element achieves a greater transmission of the optical scope 1 than comparable optical systems from the prior art. In particular, it is possible to use the optical scope 1 to observe and image an object under poor environmental conditions, e.g. at dawn or at night.

In another exemplary embodiment, it is provided to use in the optical scope 1 at least one optical element which is made of at least one of the above-named glass types for the first optical element. Additionally, this glass type may be lead-containing. This glass type has an absorption edge which is shifted into the short-wave spectrum.

### LIST OF REFERENCE NUMERALS

1 optical scope

2 first housing part

3 second housing part

4 folding bridge

5 first hinge part

6 second hinge part

7 first receptacle part

8 second receptacle part

9 third receptacle part

10 first optical axis

11 second optical axis

12 first optical subsystem

13 second optical subsystem

14A first objective lens

14B second objective lens

15A first eye

15B second eye

16A first prism system

16B second prism system

17A first ocular

17B second ocular

18A first front unit

18B second front unit

19A first focusing unit

19B second focusing unit

20 rotary knob

21A first prism

21B second prism

21C third prism

21D fourth prism

22A left-hand intermediate image plane

22B right-hand intermediate image plane

O object

1. An optical scope (1) for imaging an object (O), having
at least one first optical element (17A, 17B, 18A, 18B, 19A, 19B, 21A, 21B, 21C, 21D) made of glass, and having
at least one second optical element (17A, 17B, 18A, 18B, 19A, 19B, 21A, 21B, 21C, 21D) made of glass,
characterized in that
the first optical element (17A, 17B, 18A, 18B, 19A, 19B, 21A, 21B, 21C, 21D) is made of at least one of the following glass types: N-BK7HT, N-SK2HT, F2HT, N-LASF45HT, SF6HT, N-SF6HTultra, N-SF6HT, SF57HTultra, N-SF57HTultra, N-SF57HT, N-LASF9HT as well as N-BAK4HT;
and in that
the second optical element (17A, 17B, 18A, 18B, 19A, 19B, 21A, 21B, 21C, 21D) is made of a lead-containing glass for increasing the transmission.

2. The optical scope (1) as claimed in claim 1, characterized in that the second optical element (17A, 17B, 18A, 18B, 19A, 19B, 21A, 21B, 21C, 21D) is made of at least one of the following lead-containing glasses: K7, K10, KZFS4, KZFS5, KZFS12, LAFN7, LLF1, LF5, F2, F4, F5, SF1, SF2, SF4, SF5, SF6, SF10, SF11, SF14, SF15, SF56A, SF57, SF66, F2HT, SF6HT as well as SF57HTultra.

3. The optical scope (1) as claimed in claim 1, characterized in that the optical scope (1) has at least one objective lens (14A, 14B) which includes the first optical element (18A, 18B, 19A, 19B).

4. The optical scope (1) as claimed in one of the preceding claims, characterized in that the optical scope (1) has at least one ocular (17A, 17B) which includes the second optical element.

5. The optical scope (1) as claimed in one of the preceding claims, characterized in that the optical scope (1) has an image detection unit which is designed as a digital recording medium.

6. The optical scope (1) as claimed in one of the preceding claims, characterized in that it has at least one of the following features:
the first optical element (18A, 18B, 19A, 19B) is designed as a lens unit; or
the second optical element (17A, 17B) is designed as a lens unit.

7. The optical scope (1) as claimed in one of the preceding claims, characterized in that the first optical element (21 A to 21 D) and/or the second optical element is/are designed as a prism.

8. The optical scope (1) as claimed in one of the preceding claims, characterized in that the optical scope (1) is designed as a monocular, a binocular, a telescope, or a spotting scope.
